(19) United States
(12) Patent Application Publication
(10) Pub. No.: US 2019/0007517 A1
(43) Pub. Date: Jan. 3, 2019

(54) SENSOR PROCESSING ENGINE FOR MOBILE DEVICES

(71) Applicant: Vid Scale, Inc., Wilmington, DE (US)

(72) Inventors: Abhijith Jagannath, San Diego, CA (US); Khanim Abbo, West Edmonds, WA (US); Yuriy Reznik, Seattle, WA (US); Eduardo Asbun, San Diego, CA (US)

(73) Assignee: Vid Scale, Inc., Wilmington, DE (US)

(21) Appl. No.: 15/741,409

(22) PCT Filed: Jul. 1, 2016
(86) PCT No.: PCT/US2016/040641

§ 371 Date: Jan. 2, 2018

Related U.S. Application Data
(60) Provisional application No. 62/188,174, filed on Jul. 2, 2015.

(51) Int. Cl. H04L 29/08; G06F 8/20; G01D 5/00

(52) U.S. Cl. CPC H04L 67/303; G01D 5/00; G06F 8/20

(57) ABSTRACT

Systems, methods and instrumentalities are disclosed for supplying information about a user of a mobile device, comprising receiving a request for a characteristic of the user, receiving criteria for one or more sensors of the mobile device to be used in determining the characteristic, selecting one or more available sensors by comparing the request and criteria to available sensors and the properties of the available sensors, acquiring data from the selected available sensors, determining a property of interest from the data, the property of interest corresponding to the characteristic of the user, and sending the determined property of interest.

### CROSS REFERENCE TO RELATED APPLICATIONS

This application claims priority to U.S. Provisional Patent Application No. 62/188,174, filed Jul. 2, 2015, which is incorporated herein by reference in its entirety.

### BACKGROUND

The prevalence of mobile devices, with their wide array of built-in sensors as well as external sensors in peripheral devices which are in communication with mobile devices, presents an opportunity for developing new applications in areas such as health, advertising, multimedia, etc. However, a challenges for application developers may include how to harness, organize, and understand the streams of raw sensor data available from mobile devices and peripheral devices in communication with mobile devices. Raw sensor data by itself may not be useful, in that it may be too complex to extract useful higher-level information (e.g., information that may be meaningful and/or valuable). Extracting information from large amounts of data requires the use of advanced methods that are not within reach of a typical mobile device application developer. Therefore, what is needed are methods for sensor data processing that may extract and/or derive information about a user and provide that information (e.g., not raw sensor data) to applications.

### SUMMARY

Systems, methods and instrumentalities are disclosed for supplying information about a user of a mobile device, comprising receiving a request for a characteristic of the user, receiving criteria for one or more sensors of the mobile device to be used in determining the characteristic, selecting one or more available sensors by comparing the request and criteria to available sensors and the properties of the available sensors, acquiring data from the selected available sensors, determining a property of interest from the data, the property of interest corresponding to the characteristic of the user, and sending the determined property of interest. The criteria may include one or more sensors of the mobile device which are allowable (or not allowable) to be used in determining the characteristic of the user.

Systems, methods and instrumentalities are disclosed for devices comprising one or more sensors, and a processor configured to receive a request from an application for a characteristic of a user of the mobile device and criteria for one or more sensors of the mobile device to be used in determining the characteristic, determine a property of interest of the user corresponding to the user characteristic using sensor data obtained from sensors meeting the sensor criteria, and provide the determined property of interest to the application without sensor data (e.g., raw sensor data). The sensor criteria may include one or more sensors of the mobile device which may (or may not) be used in determining the characteristic of the user.

### BRIEF DESCRIPTION OF THE DRAWINGS

FIG. 1 is an example of a high-level architecture of a Sensor Processing (SP) Engine implemented in a Software Development Kit (SDK).

FIG. 2 is an example of SP SDK interfaces.

FIG. 3 is an example of SP SDK function.

FIG. 4 shows an example of a sensor processing interface.

FIG. 5 shows examples of sensor processing interfaces.

FIG. 6 shows an example of automatic device generation.

FIG. 7 shows an example of external sensors.

FIG. 8 shows an example of platform processing modes.

FIG. 9A is a system diagram of an example communications system in which disclosed technology be implemented.

FIG. 9B is a system diagram of an example wireless transmit/receive unit (WTRU) that may be used within the communications system illustrated in FIG. 9A.

FIG. 9C is a system diagram of an example radio access network and an example core network that may be used within the communications system illustrated in FIG. 9A.

FIG. 9D is a system diagram of an example radio access network and an example core network that may be used within the communications system illustrated in FIG. 9A.

FIG. 9E is a system diagram of an example radio access network and an example core network that may be used within the communications system illustrated in FIG. 9A.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application.

A prevalence of mobile devices and a wide array of built-in sensors may support development of applications, for example, in a variety of areas such as health, advertising and multimedia. Raw sensor data streams available in mobile devices may be harnessed, organized and understood, for example, to extract high-level, meaningful, useful and/or valuable information. As an example, applications may use sensors in mobile devices to present fitness information to runners (e.g., time, distance, elevation, route in a map).

Wearable devices (e.g., Apple Watch) is a category of mobile devices that may enable an enhanced level of personalized applications. A wearable may be in close proximity to a user, e.g., for long periods of time. An application may provide relevant information to a wearable user, e.g., during a search or during the course of a user's daily routine, for example, by using sensor processing algorithms on data available from a wearable device.

Information may be extracted from large amounts of sensor data, e.g., for access and use by mobile device application developers. A general framework and API for sensor data processing may be useful for variety of applications that need information about a user, e.g., to optimize behavior.

Sensor data in mobile devices may be captured and used, for example, to obtain a variety of information about users, their context, viewing conditions and environmental factors that may, for example, affect how a device is used. Information may comprise, for example, information about user characteristics (e.g., age, gender, height, weight, BMI, expression and emotion), context-specific information (e.g., user activity and device state) and information about user environmental conditions (e.g., location, ambient light and screen contrast).

A device may be characterized, for example, by determining what sensors are available on the device and their characteristics. Device-specific classifier algorithms may be designed, for example, to determine user characteristics, context-specific information and/or environmental condition information based on device-specific knowledge. However, a device-specific solution may not scale well because different devices may have different sensors with different properties, which may lead to device-specific classification algorithms for each of various differing devices. A sensor processing framework may be designed for different devices having different sensors with different properties.

An application may have preferences or requirements regarding which sensors are used to produce user characteristics, context-specific information and/or environmental condition information. For example, a first application may request the age and current emotional state of a user and may not care which sensors are used to determine such information. A second application may request the age and emotional state of the user, but may prefer or require (e.g., for privacy reasons) that non-camera sensors (e.g., accelerometers and/or orientation sensors) be used to determine age and emotional state information. A sensor processing framework may be designed to address application specific preferences or requirements (e.g., which sensors are allowable (or not allowable) for use in determining user characteristics).

The state and availability of sensors may change over time. For example, a particular sensor such as a device camera or an ambient light sensor may not be available when being used by another application or when a requesting application is running in the background. As another example, an accessible sensor may be located on a secondary device, which may or may not be present at a given time. A sensor processing framework may be designed to react dynamically to the changing availability of sensors.

Systems, methods and instrumentalities are disclosed for a Sensor Processing (SP) Engine that may be implemented in a Software Development Kit (SDK) for mobile devices. An SP framework may adapt to different devices having different sensors with different properties, different applications having application specific preferences or requirements and a dynamically variable availability of sensors.

An SP Engine may permit specification (e.g., in an application) of preferences and/or requirements for a set of sensors that may be used to obtain one or more properties of interest. For example, an application may specify (e.g., via an SP SDK API call) one or more sensors to be used and/or not to be used (e.g., allowable and/or not allowable) to compute or determine a property of interest. Sensor availability may determine the scope of properties that an SP SDK enables.

An SP Engine may have access to a database of device profiles that may describe one or more characteristics (e.g., sampling rate, camera resolution) and/or limits (e.g., calibration, operating range) of sensors in a device. An SP Engine may use a combination of sensors, for example, to produce a more accurate result, such as when a sensor has limited precision. An SP Engine may rely on a particular sensor more heavily (e.g., may weigh sensor information), for example, when a sensor may be more effective than other sensors or more effective on a first device than on a second device. A database of device profiles may be available locally (e.g., on a primary device that may be running an SP SDK) or remotely (e.g., stored on a server accessible via a network or “in the cloud”). An SP Engine may request device profiles from a database, for example, by sending requests to the database over a network.

An SP Engine may select from a library of algorithms and classifiers the most suitable algorithms and classifiers to determine or compute a property of interest for the types, properties and/or limitations of sensors available on devices (e.g., per device profiles) and/or sensor requirements of an application.

An SP Engine may search for and/or detect nearby devices (e.g., accessory devices such as smart glasses (e.g., Google Glass), smart watches (e.g., Apple Watch), exercise bands (e.g., Fitbit), shoe sensors (e.g., Nike+ sensor or Adidas MiCoach stride sensor), etc.), that may have additional sensors. An SP Engine may access a device profile of an additional device, e.g., in the database of device profiles. An SP Engine may examine a device profile to determine what sensors may be available via the additional device and/or to determine characteristics, properties, and/or limitations of sensors. An SP Engine may select from a library of available algorithms and classifiers an algorithm or classifier suitable to determine a property of interest based on the sensors available on a primary device and sensors available on one or more additional devices. An SP engine may obtain sensor data from a primary device and/or additional devices (e.g., accelerometer, orientation, ambient light, camera, heart rate, galvanic skin response (GSR)). Sensor data from additional devices may be obtained via any available connection between a primary device and an additional device (e.g., Bluetooth, WiFi). An SP engine may pass sensor data to one or more selected algorithms or classifiers to determine or compute one or more properties of interest.

An SP Engine may provide applications with access to classifications. A classification may be, for example, a class of information about a user, user context, user environment, user device, etc. Information about a user may comprise, for example, age, gender, ethnicity, weight, height, body mass index (BMI), handedness, dexterity, etc. Information about user context, e.g., context-specific information about user, may comprise, for example, a user activity (e.g., stationary, walking, running, riding), a user relation to a device (e.g., holding in hand, on lap, on stand), user attention (e.g., looking at a screen, proximity to a screen), user emotion (e.g., valence, arousal etc. Information about a user environment may comprise, for example, user location, ambient light, ambient noise floor, etc. Information about a user device may be, for example, form-factor, size, weight, effective resolution, effective contrast, etc. Effective resolution and/or effective contrast may be useful for an application developer, for example, to determine which fonts to use in application annotations.

An SP Engine may use gating, for example, to provide additional determination of user metrics. As an example, a classifier associated with an SP Engine may have logic that may determine a user information metric based on sensor data. A classifier may be designed, for example, for sensor data collection while a user is in a particular activity state. As an example, user weight and height may be determined based on sensor readings taken while the user is in a walking' state. An SP Engine may gate a classifier's determination of weight and height or may gate sensor data provided to the classifier, for example, based on detecting that the user is in a ‘walking’ state. A fusion of multiple processed sensors may permit granular classification.

An API for an SP Engine may, for example, permit classification information to be collected with reduced or minimal resource deployment, which may reduce or minimize an impact on battery life and application performance.

An SP Engine may support multiple apps simultaneously (e.g., concurrent applications). An SP engine may be embedded in a variety of platforms, such as Apple iOS, Google Android and Microsoft Windows.

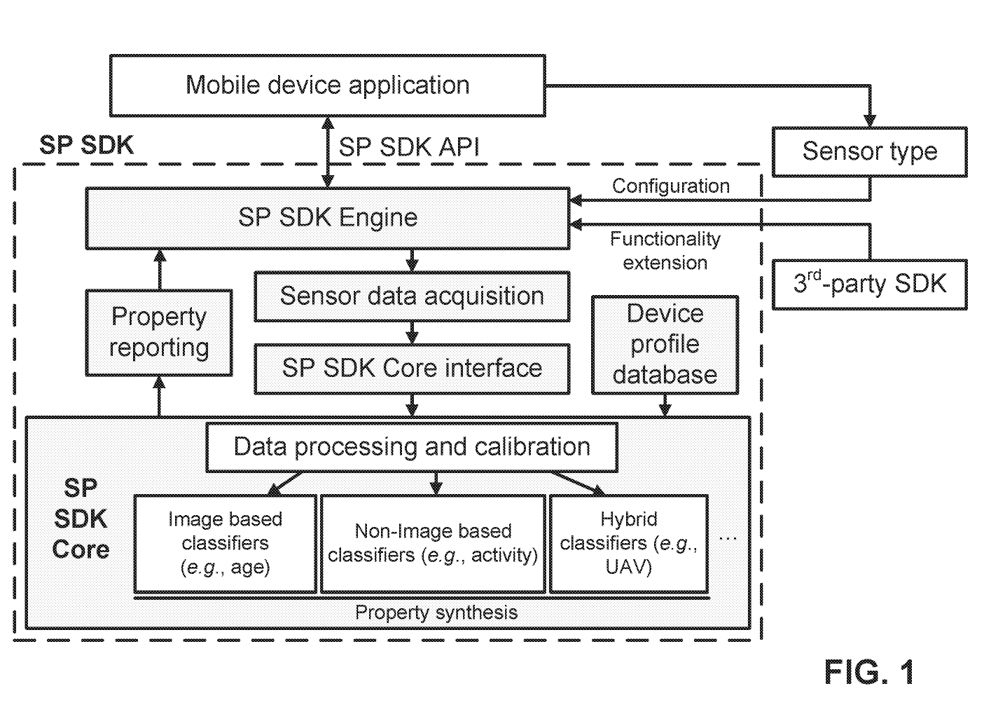

FIG. 1 is an example of an interaction between the Sensor Processing (SP) Software Development Kit (SDK) and a mobile device application. Communication between these two modules may occur through an API. The SP SDK Engine may receive requests for characteristics of a user from the mobile device application. The SP SDK Engine may deliver properties of interest. The SP SDK Engine may manage on-device sensors (e.g., sensor detection, sensor configuration, start/stop acquisition, etc.) and external sensors (if any). Configuration parameters about sensor types to use (or not to use) may also be provided by means other than an API (e.g., build-time configuration, libraries enabled/disabled, license files, etc.). The SP SDK Core may select one or more classifiers based on sensor availability, configuration and device profile information. The SP SDK Core may input sensor data and perform classification needed to provide requested properties of interest, which may be reported back to the SP SDK Engine.

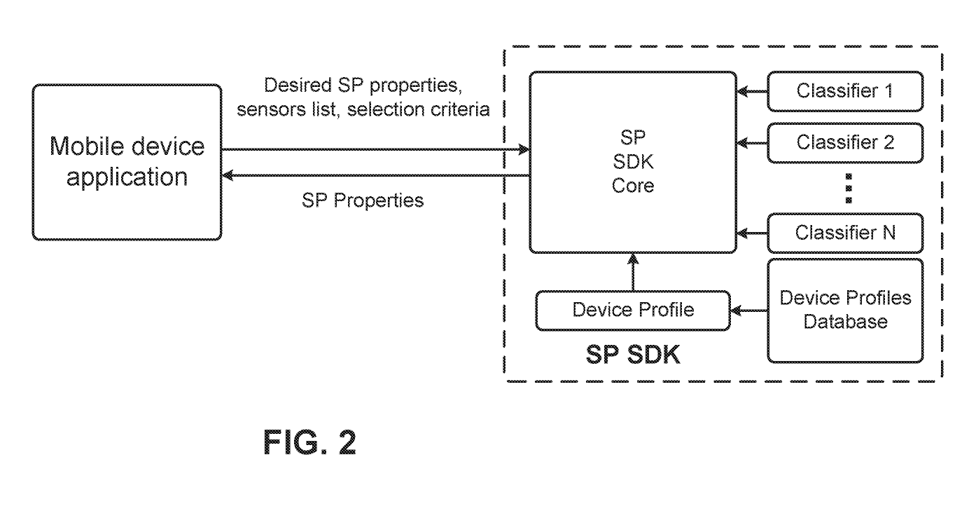

FIG. 2 is an example of interfaces in a high-level architecture of an SP SDK, illustrating possible parameters in SP SDK API requests from the mobile device application to the SP SDK. For example, the application may provide a list of the desired properties of interests (e.g., gender), a list of sensors to use or not use (e.g., use only non-image based classifiers), and some criteria for selecting classifiers (e.g., use algorithms with low power consumption). The SP SDK may use the information in the request, plus device profile information, to select one or more classifiers for obtaining the property of interest and report it back to the application.

Returning to FIG. 1, an SDK may comprise one or more logical entities or modules, such as an SP Engine, Sensor data acquisition, SDK Core interface, SP SDK Core, and SP Property reporting. An SP Engine may be implemented, for example, in the form of an SDK, e.g., for iOS and/or Android. An SP SDK may be invoked (e.g., by iOS and/or Android applications), for example, via an (e.g., a public) SDK Application Programming Interface (API). An SP SDK may collect various sensor data, which may be passed to an SDK core. An SDK core may perform sensor data filtering, calibration and processing of collected sensor data, for example, to deduce a property of interest, e.g., one or more properties or classifications that a sensor processing framework, algorithms or plugins may determine (e.g., user characteristics, context-specific information and/or environmental condition information).

An SP SDK may support third-party SDKs, e.g., third party classifier plugins, which may provide functionality extensions and may be capable of processing sensor information to determine the properties of interest. A third party SDK may register with the SP SDK (e.g., with the SP Engine). A third-party SDK may be capable of providing one or more properties of interest. A third-party SDK may be capable of determining one or more properties of interest, e.g., based on a data from one or more sensor inputs, and/or providing one or more properties of interest. A third party SDK may indicate which sensors types of sensors) may be utilized or required. A third-party SDK may indicate, for example, to the SP SDK (e.g., to the SP Engine), one or more properties of interest it may provide, sensor input requirements and/or constraints. Examples of constraints may be a minimum sampling rate for sensor data, a precision of sensor data values, an accuracy level of a sensor, unit designations for data, etc. Information may be provided by a third-patty SDK, for example, during an initial registration stage and/or when the third party SDK is running.

An SP SDK may receive information (e.g., initialization information) from a mobile device application. Initialization information may comprise, for example, one or more properties of interest, a sensor specification, classifier selection criteria, etc.

Initialization information may comprise, for example, one or more properties that a mobile device application may be interested in obtaining from an SP SDK (e.g., characteristics of a user of the mobile device, such as height, weight, age, gender, and/or emotional state).

Initialization information may comprise, for example, a sensor specification, which may indicate, constrain or configure a set of sensors (or sensor types) that may be used (e.g., is allowable) to derive one or more properties of interest, for example, as shown by a “configuration” interface in FIG. 1. As an example, a mobile device application may request that an SP SDK use one or more sensors (e.g., use camera only), not use one or more sensors (e.g., only use accelerometer and do not use the camera) and/or a mobile device application may not have a preference on which sensors the SP SDK may use, relying on the SP SDK to use sensors suitable for obtaining the properties of interest.

Initialization information may comprise, for example, a criteria used to select from several candidate classifiers, e.g., criteria specifying use of the most accurate classifier, use of a classifier with the lowest CPU requirements, etc.

An SP SDK may have a library of classifiers. A classifier may be used to derive one or more properties. Some classifiers in a library may overlap, e.g., they may determine one or more of the same or similar properties. An SP SDK may obtain information about one or more classifiers.

Classifier information may indicate one or more properties of interest that a classifier may be used to determine. For example, a first classifier may determine age only while a second classifier may determine age and gender.

Classifier information may indicate one or more sensors that a classifier may or must rely on or use to determine one or more properties. For example, a first classifier may use only an accelerometer to determine one or more properties while a second classifier may use only a camera and a third classifier may use a combination of an on-device accelerometer and sensor information from an external device (e.g., Apple Watch, Fitbit, pedometer).

Classifier information may indicate requirements for a classifier (e.g., what sensors it utilizes, minimum sensor accuracy). For example, a first classifier may use sensor data from an accelerometer with a minimum sampling rate of 100 Hz while a second classifier may use sampling data from an accelerometer with sampling rate of 20 Hz and a third classifier may use sensor data from an accelerometer with a minimum accuracy of ±0.1 m/s².

Information about a classifier may be obtained during registration, for example, when a classifier provides information when it is registered with the SP Engine. Information about a classifier may be obtained at any time, e.g., via an API. As an example, an SP Engine may query a classifier to request information about properties of interest the classifier may provide and the sensors and sensor constraints for the classifier. A query for classifier information may be in response to an application requesting determination of a property of interest.

An SP SDK may have access to a database of device profiles to obtain a profile for one or more devices (e.g., a primary device, a device on which the SP SDK is running, an accessory device). A database may maintain information about a device's sensors (e.g., accuracy, sensitivity, sampling rate and response characteristics of accelerometers). Information about device sensors in a database may or may not be available via an API. An SP SDK may query a database to learn about properties of sensors on a device and may use this information to select one or more appropriate classifiers to determine one or more properties a mobile device application is interested in.

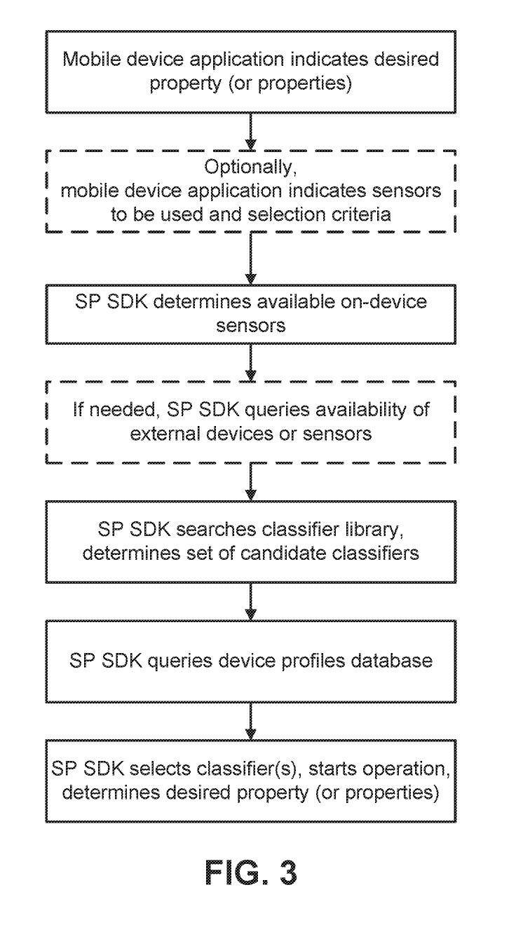

FIG. 3 is an example of selecting classifiers in an SP SDK. A mobile device application may indicate one or more properties it is interested in obtaining from the SP SDK. A mobile device application may provide a sensor specification, which may indicate a set of sensors that the mobile device application prefers or requires an SP SDK to use and/or to not use to determine or derive the one or more properties of interest. A mobile device application may provide criteria that may or must be used for selecting classifier(s).

An SP SDK may determine on-device sensor availability, for example, using mobile device operating system (OS) capabilities.

An SP SDK may determine whether an external device is available and whether it may provide useful sensor data, for example, when sensor data from an external device (e.g., Apple Watch, Fitbit, pedometer) may be useful or required to determine the properties of interest. An SP SDK may determine that a sensor or sensor type (e.g., used or required by an application or as input to an algorithm or classifier to determine or compute a property of interest) is not available on a primary device. An SP SDK may search available external devices, for example, to determine whether an available external device may have or may provide a sensor or sensor type.

An SP SDK may obtain a set of candidate classifiers from a library, for example, based on properties of interest and sensor availability.

An SP SDK may query a device profile database, for example, to learn on-device or external sensor characteristics and/or limitations, which information an SP SDK may use to select or reduce a list of candidate classifiers.

An SP SDK may select one or more appropriate classifiers and may start a process to obtain requested properties. An SP SDK may select one or more classifiers using a provided or built-in criteria. As an example, an SP SDK may select a classifier that has the lowest power requirement, highest degree of accuracy, etc.

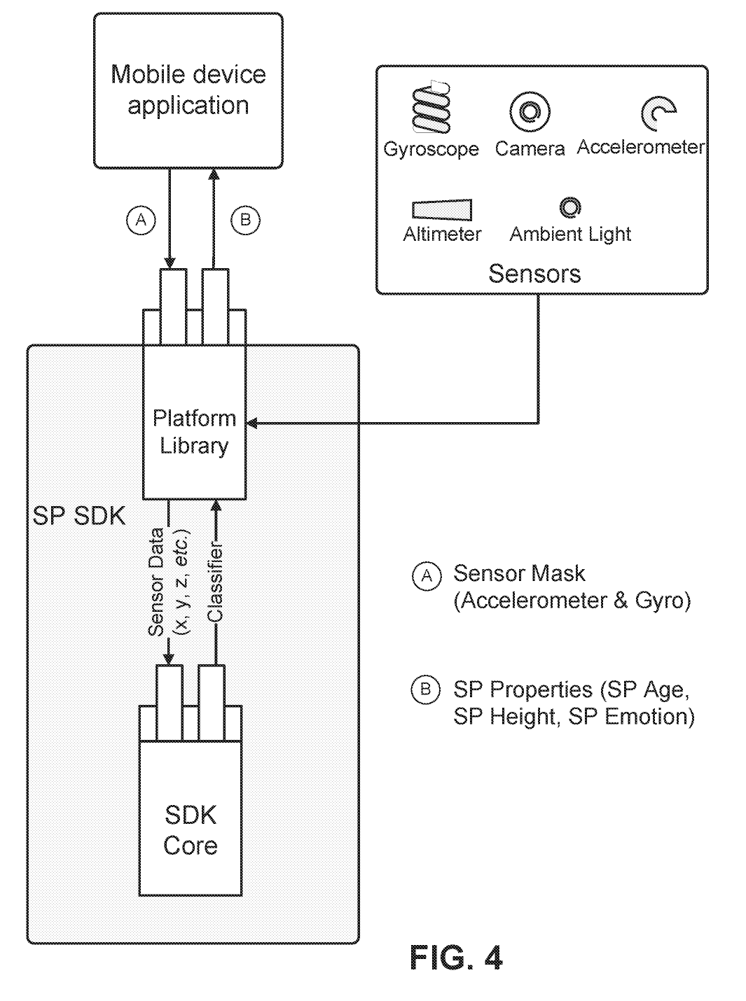

FIG. 4 shows an example of a sensor processing interface. FIG. 4 shows an SP SDK interface. An application (e.g., App) may specify a requested sensor list (e.g., sensor bitmask), for example, during SDK initialization. An App may request SP Property classifications, for example, when an SDK has been started. A platform library may receive sensor data from one or more sensors. A platform library may apply a sensor selection (e.g., specification of sensors to be use or not to be used (e.g., allowable or not allowable) provided by an App. Sensor data may be provided by a platform library to an SDK core. An SDK core may provide classifiers to a platform library. A platform library may provide SP properties to an App.

An SDK may comprise, for example, a platform library and an SDK Core library. A platform library may use an operating system, for example, to retrieve sensor data and push it to a cross platform SDK Core library. A platform library may utilize one or more available platform hardware accelerated features, e.g., for improved classification performance. An SDK Core may be a cross platform library that performs classification calculations. Classification results may be retrieved, for example, by a platform library. A platform library may analyze or evaluate one or more classification determinations for further (e.g., refined, hierarchical) classification. Classification determinations may be fused (e.g., merged or combined), for example, to make one or more additional classifications. As an example, an accelerometer based activity determination may be combined with altimeter data to determine, for example, a stairs activity.

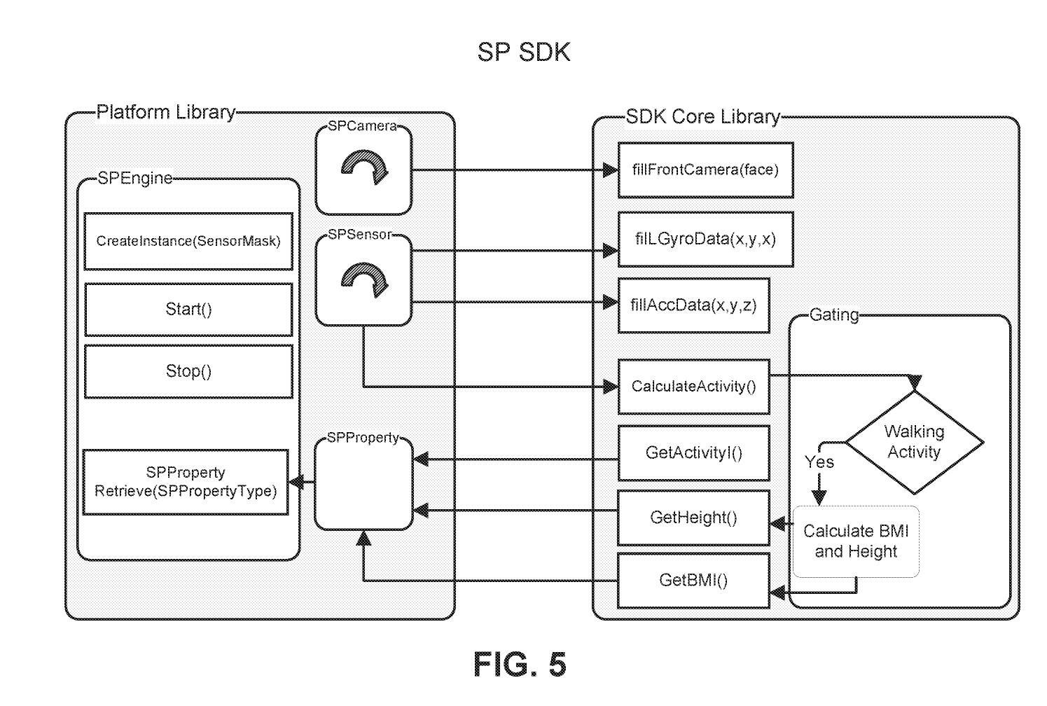

FIG. 5 shows examples of sensor processing interfaces. FIG. 5 shows examples of SP SDK interfaces. An SP SDK may comprise a platform library and an SDK core library. An Application may control an SDK with Stop/Start functionality. An operating system may drive an SDK sensor collection, e.g., via. CallBacks, for example, once Start is called.

Sensor data may be pushed to a (e.g., an appropriate) SDK Core procedure. Sensor data may be stored, for example, as a circular buffer inside a core library. A core library may have a set of adaptive classifiers running with its own thread. Property classification may be performed with timing precision, which may be indicated by one or more classifiers. A platform SDK may call a Get method from the SDK Core, for example, in response to an App request for an SP Property classification. An SDK Core may calculate and return a requested classification or may return a pre calculated requested classification. A classification may be derived from input sensor data. An SDK Core may use gating, for example, to determine further classification. As an example, BMI and Height may be further classified for an accelerometer based “Walking” activity classification.

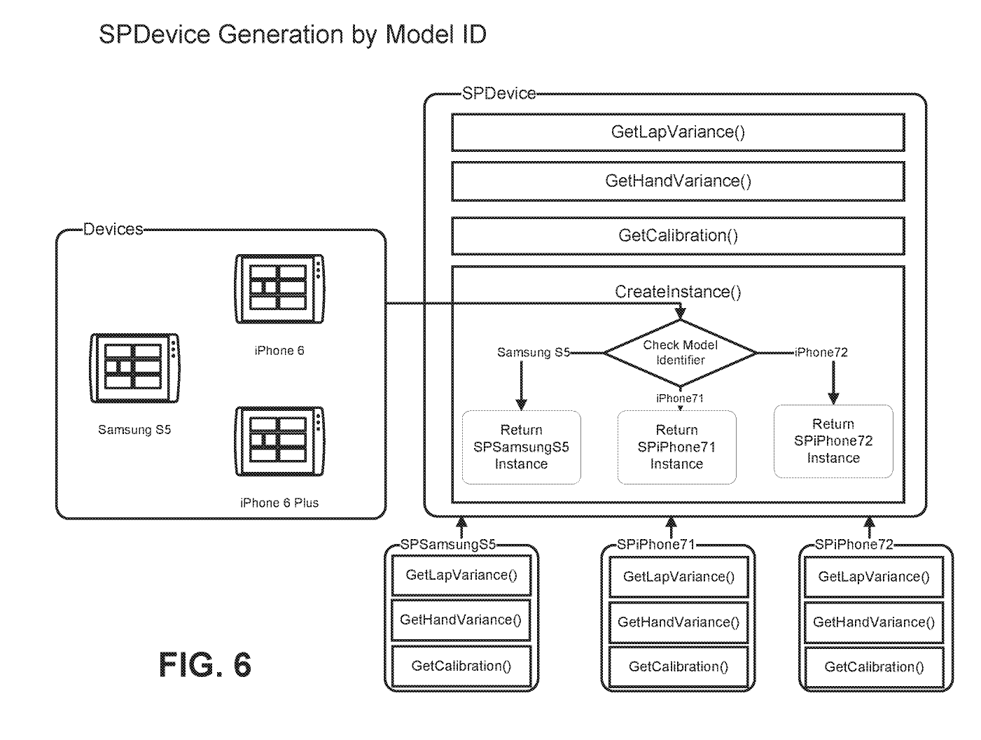

FIG. 6 shows an example of automatic device generation (e.g., automatic generation of a device-specific sensor processing object). SP SDK classifications may be dependent on device characteristics. Onboard sensors (e.g., sensors on or in a device) may have, for example, different sensitivities and ranges that may be accounted for, e.g., during SDK property synthesis. FIG. 6 shows an example of automatic creation of a device object for an SDK. Device-specific objects may, for example, implement inherited interfaces and values from a parent (e.g., a generic parent) SPDevice object and may (e.g., further) comprise their own device-specific details. A parent SPDevice object may have a createInstance( ) procedure, which may automatically return a device-specific singleton instance, e.g., according to a Model identifier that the operating system reports to. Device-specific instantiation may permit an SP SDK SPEngine to automatically instantiate an object that represents a housing device.

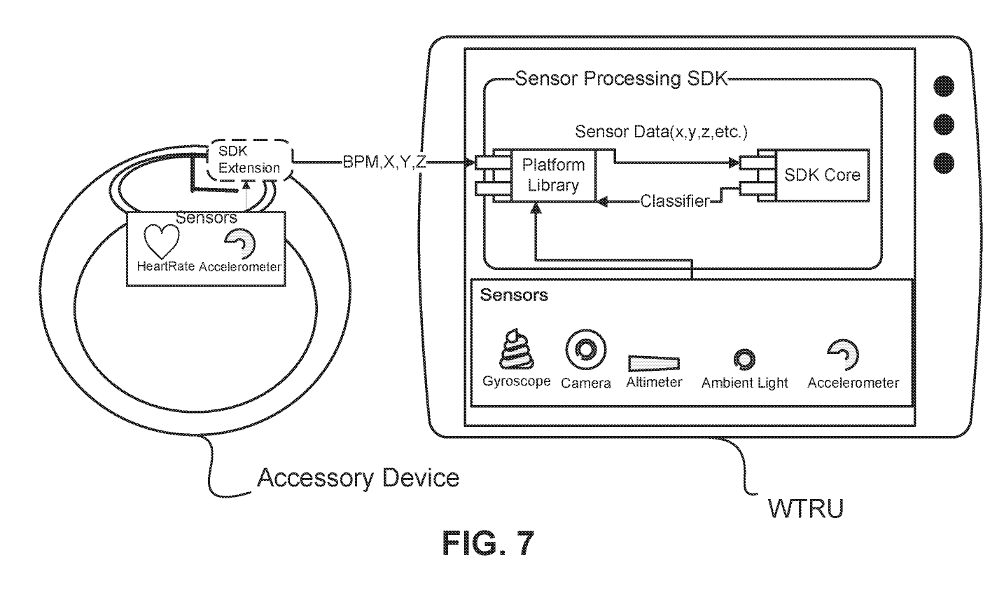

FIG. 7 shows an example of external sensors. FIG. 7 shows how additional sensors, e.g., from external accessories, may be plugged into an SP SDK. An SP SDK may have multiple modes of operation, which may depend on capabilities or functionalities of external accessories. An SP SDK may query a device for a list of registered external accessories. An SP SDK may attempt to establish a connection with one or more external accessories that may provide sensor data. An external accessory may be visible to a device, for example, after a user pairs them (e.g., Bluetooth or Wi-Fi) or connects them (e.g., using a cable).

An SDK may install and load extension software on an accessory device. An SDK may forward accessory sensor data, for example, using an extension to a main SDK over a data bridge. Accessory sensors may provide (e.g., add) activity classifications, such as “eating” and other states based on motion, e.g., limb motion. Accessory sensors may increase classification confidence. As an example, activity classification may use heart BPM and accelerometer data from one or more accessory sensors.

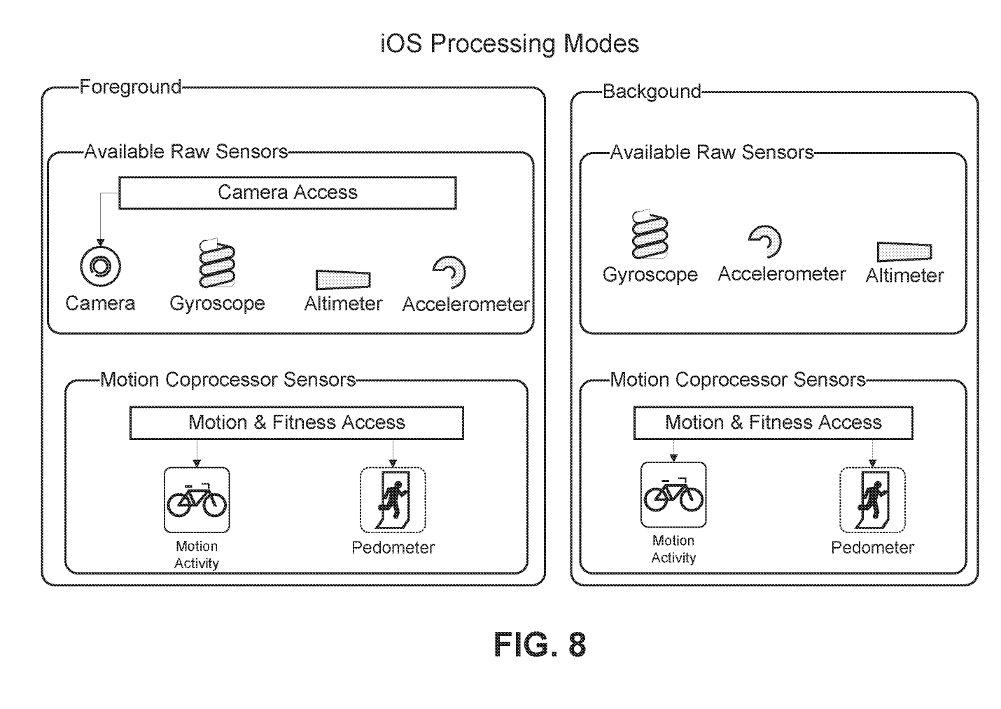

FIG. 8 shows an example of platform processing modes. FIG. 8 shows examples of different sensor processing modes for iOS. Examples of platforms and sensor processing modes are presented as examples. A similar set of modes (or different modes) may be implemented for Android or another platform. Sensors may be available continuously, periodically or conditionally, such as when an iOS App/SDK is in the foreground and responsive to user input. As an example, an (e.g., iOS) operating system may limit camera sensor access when an App/SDK is running in the background, which may limit (e.g., render unavailable) camera based classification by the SDK.

An operating system (e.g., iOS) may provide a user with an ability to disable sensors for an application, e.g., during foreground and/or background execution.

Table 1 provides an example of SP SDK API package classes.

TABLE 1
Class Summary

| Class | Description |
|---|---|
| SPDevScreeenResolution | Effective resolution |
| SPDevScreenContrast | Effective contrast |
| SPDevSignalToNoise | Effective contrast |
| SPEngine | Main sensor SDK engine |
| SPEnvAmbientLight | Ambient light |
| SPEnvAmbientNoise | Ambient noise |
| SPEnvLocation | Location |
| SPProperty | Parent class for properties |
| | reported by SPEngine |
| SPUserActivity | User activity |
| SPUserAge | User age |
| SPUserAttention | User attention |
| SPUserDeviceUse | User device use classifier: |
| SPUserEmotionalState | Location |
| SPUserEthnicity | User ethnicity |
| SPUserGender | User gender |
| SPUserHeight | User height |
| SPUserProximityToScreen | User proximity to screen |
| SPUserWeight | User weight |

Table 2 provides an example of SP SDK API enumerated (enum) types.

TABLE 2
Enum Summary

| Enum | Description |
|---|---|
| SensorType | Sensor types, labeled as bitmasks, |
| | allowing combination. |
| SPPropertyState | State of property |
| SPPropertyType | User/environment property types/IDs |
| UserActivityType | User activity types |
| UserDeviceUseType | Device use types |
| UserEthnicityType | Ethnicity types |
| UserGenderType | Gender types |

A class hierarchy, e.g. for classes in Table 1, may be implemented, for example, in Java:

```
java.lang.Object
    com.interdigital.spsdk.SPEngine
    com.interdigital.spsdk.SPProperty
        com.interdigital.spsdk.SPDevScreeenResolution
        com.interdigital.spsdk.SPDevScreenContrast
        com.interdigital.spsdk.SPDevSignalToNoise
        com.interdigital.spsdk.SPEnvAmbientLight
        com.interdigital.spsdk.SPEnvAmbientNoise
        com.interdigital.spsdk.SPEnvLocation
        com.interdigital.spsdk.SPUserActivity
        com.interdigital.spsdk.SPUserAge
        com.interdigital.spsdk.SPUserAttention
        com.interdigital.spsdk.SPUserDeviceUse
        com.interdigital.spsdk.SPUserEmotionalState
        com.interdigital.spsdk.SPUserEthnicity
        com.interdigital.spsdk.SPUserGender
        com.interdigital.spsdk.SPUserHeight
        com.interdigital.spsdk.SPUserProximityToScreen
        com.interdigital.spsdk.SPUserWeight
```

SPEngine may be a main or primary SP SDK engine, for example, to provide an interface to application development. Table 3 provides example procedures (e.g., methods).

TABLE 3

| Modifier | |
|---|---|
| and Type | Procedure and Description |
| static SPEngine | createInstance(SPSensorType[ ] sensors, Context ctx) |
| | Creates and returns an instance of an SP engine |
| int | curUserID( ) |
| | Retrieves current user id |
| static SPEngine | getInstance( ) |
| | Returns an instance of an SP engine |
| java.lang.Boolean | isRetrievable(SPPropertyType propertyType) |
| | Check if property is retrievable |
| void | pause( ) |
| | background\minimum processing mode |
| SPProperty | Retrieve(SPPropertyType propertyType) |
| | Retrieve specific property |
| void | start( ) |
| | Starts the Engine to process data |
| void | stop( ) |
| | Stops the Engine and data processing |
| int | users( ) |
| | Retrieves number of users detected for a device |
| | (e.g., phone) |

Sensor types may be enumerated. A base class SensorType may be specified for enumerated sensor types, for example, in Java:

Enum SensorType
java.lang.Enum<SensorType>
com.interdigital.spengine.SensorType

Table 4 presents an example of enumerated sensor types.

TABLE 4

| Enum Constant | Description |
|---|---|
| Accelerometer | Accelerometer |
| Camera | Camera |
| DynPerspective | amazon fire phone's dynamic perspective sensor |
| GPS | GPS Sensor |
| Gravity | Gravity |
| Gyroscope | Gyroscope |
| Humidity | Relative ambient humidity in percent (%) |
| Light | ambient light in lux |
| LinAcceleration | linear acceleration |
| MagneticField | magnetic field |
| Microphone | Microphone |
| Orientation | Device orientation |
| Pressure | ambient air pressure in hPa |
| Proximity | User proximity |
| Temperature | Ambient temperature in Celsius (° c.) |
| Touch | Touch Screen |

A base class, e.g., SPProperty, may be specified, e.g., in Java, for subclasses representing various categories of properties:

public class SPProperty
extends java.lang.Object

An example of subclasses representing various categories of properties may be:

SPevScreeenResolution

SPDevScreenContrast

SPDevSignalToNoise

SPEnvAmbientLight

SPEnvAmbientNoise

SPEnvLocation

SPUserActivity

SPUserAge

SPUserAttention

SPUserDeviceUse

SPUserEmotionalState

SPUserEthnicity

SPUserGender

SPUserHeight

SPUserProximityToScreen

SPUserWeight

Table 5 presents example procedures (e.g., methods) related to properties, such as retrieving a type, state or confidence score of a property.

TABLE 5

| Modifier and Type | Procedure and Description |
|---|---|
| float | confidence( ) |
| | Retrieve confidence score for a retrieved property: |
| SPPropertyState | state( ) |
| | Retrieve property state: |
| SPPropertyType | type( ) |
| | Retrieve property type: |

An SPPropertyState procedure, e.g., as shown in Table 5, may indicate a variety of property states. Table 6 presents examples property states for one or more properties.

TABLE 6

| Enum Constant | Description |
|---|---|
| Available | property values can be used |
| NotAvailable | can't be retrieved given restriction on sensors |
| NotReady | need additional data collection to produce it |

An SPPropertyType procedure, e.g., as shown in Table 5, may indicate a variety of property types. Table 7 presents examples of property types.

TABLE 7

| Enum Constant | Description |
|---|---|
| DevScreeenResolution | Effective screen resolution |
| DevScreenContrast | Effective screen contrast |
| DevSignalToNoise | Effective signal to noise ratio dB |
| EnvAmbientLight | Ambient light, lux |
| EnvAmbientNoise | Ambient noise level, dB |
| EnvLocation | User location, GPS coordinates |
| Unknown | reserved for use in error situations |
| UserActivity | User activity (e.g., walking, running) |
| UserAge | User Age |
| UserAttention | Attention level |
| UserDeviceUse | Device usage (e.g., in hand, on lap) |
| UserEmotionalState | Valence, arousal, etc |
| UserEthnicity | User Ethnicity |
| UserGender | User Gender |
| UserHeight | UserHeight |
| UserProximityToScreen | Distance to screen, in inches |
| UserWeight | UserWeight |

Applications (e.g., programs) may be implemented in Java, for example. In an example, an SDK may be used to retrieve ambient light periodically (e.g., every one second):

/**
======================================================

| | |
|---|---|
| * | Copyright (c) 2014 |
| * | InterDigital Communications, Inc. |
| * | All rights reserved. |

======================================================

| | |
|---|---|
| * \file | SPExample.java |
| * \brief | Example application |
| * \details | Example showing use of SP SDK retrieving ambient |
| light | |

======================================================
*/
package com.interdigtal.spdemo;
/* Java timer imports */
import java.util.Timer;
import java.util.TimerTask;
/* Android activity imports */
import android.app.Activity;
import android.os.Bundle;
import android.os.Handler;
import android.widget.TextView;
/* SDK imported form jar file */
import com.interdigital.spsdk;
public class SPExample extends Activity {
private SPEngine sp_engine; ///< instance of engine

| | |
|---|---|
| private SPEnvAmbientLight sp_property; | ///< instance of property |
| to be retrieved | |
| private Timer mTimer; | ///< Timer object to |
| trigger every second | |
| private float ambLight; | ///< Value of the property |
| retrieved | |
| private TextView mUpdateTxt; | ///< Text on screen to |

```
update
      @Override
      protected void onCreate(Bundle savedInstanceState) {
        super.onCreate(savedInstanceState);
        setcontentView(R.layout.activity_spexample);
        /* get the text view to update */
        mUpdateTxt = (TextView) findViewById(R.id.textView2);
        /* define what sensors SDK may use */
        SPSensorType sp_sensors[ ] = {SPSensorType.Camera,
SPSensorType.Light };
        /* create an instance of SDK */
        sp_engine = SPEngine.createInstance(sp_sensors,
getApplicationContext( ));
      }
      @Override
      protected void onStart( ) {
        /* start the engine */
        sp_engine.start( );
        // Setup timer if needed
        if (mTimer == null) {
          mTimer = new Timer( );
          mTimer.schedule(checkState, 1000, 1000);
        }
    }
    @Override
    protected void onStop( ) {
      /* application about to die, stop the engine */
      sp_engine.stop( );
      /* take care of timer */
      mTimer.cancel( );
      mTimer.purge( );
      mTimer = null;
    }
    @Override
    protected void onPause( ) {
      /* application went background, minimize processing */
      sp_engine.pause( );
    }
/**
*  \brief Timer task performed every second
*/
private TimerTask checkState = new TimerTask( )
{
    @Override
    public void run( ) {
      /* Retrieve the property if it is retrievable */
      if(sp_engine.isRetrievable(SPPropertyType.EnvAmbientLight))
      {
        sp_property =
sp_engine.Retrieve(SPPropertyType.EnvAmbientLight);
      }
      /* get the value of the retrieved property */
      ambLight = sp_property.ambientLight( );
      /* update results */
      mHandler.post(mUpdateResults);
    }
  };
  /* handler to update results */
  Handler mHandler = new Handler( );
  /* Update results to screen */
  Runnable mUpdateResults = new Runnable( )
  {
    @Override
    public void run( )
    {
      mUpdateTxt.setText (Float.toString(ambLight));
    }
  };
}
```

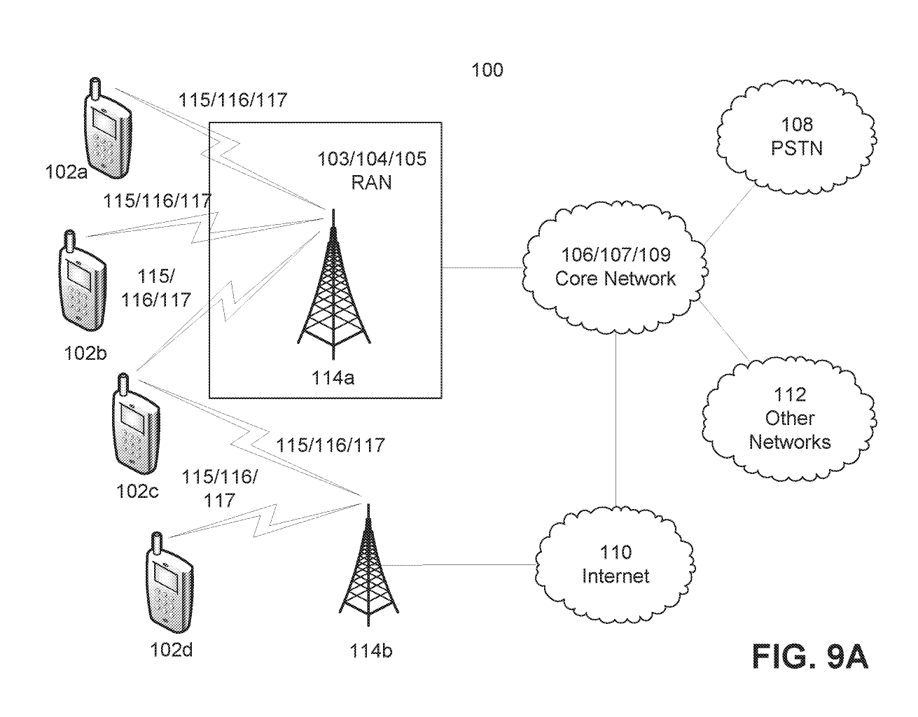

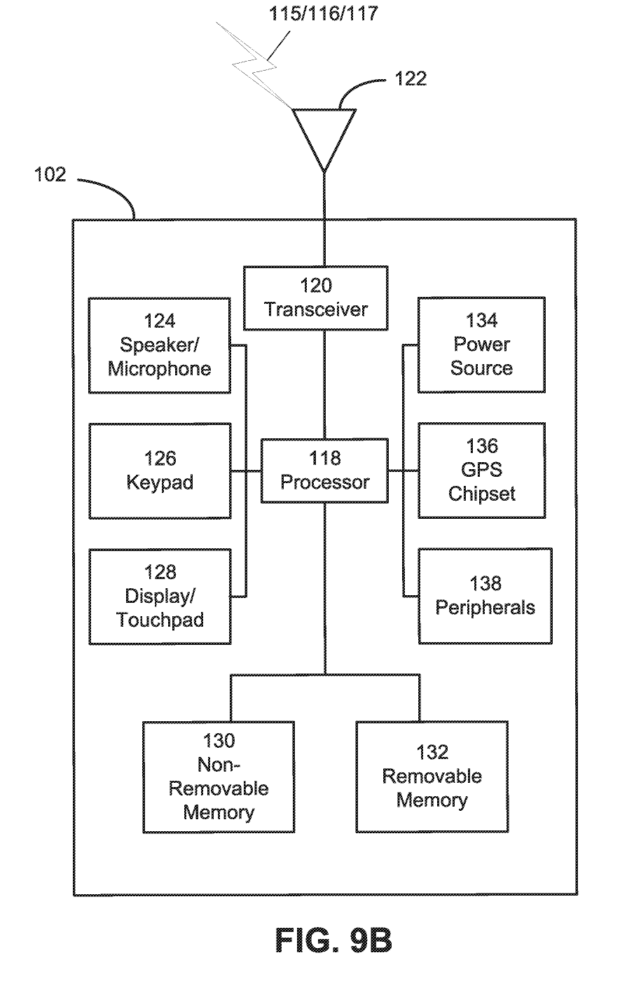

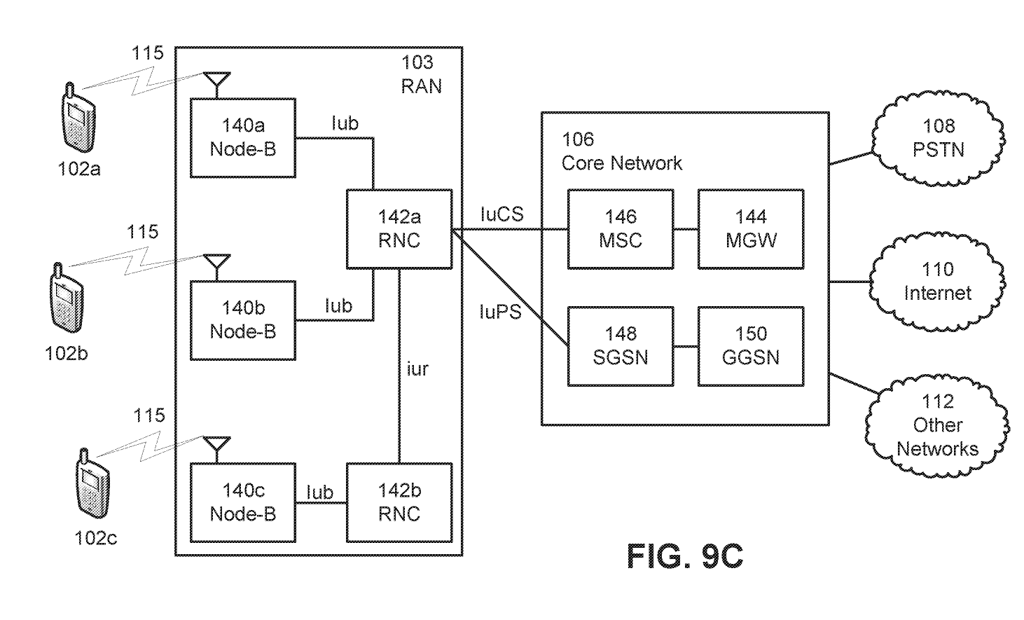

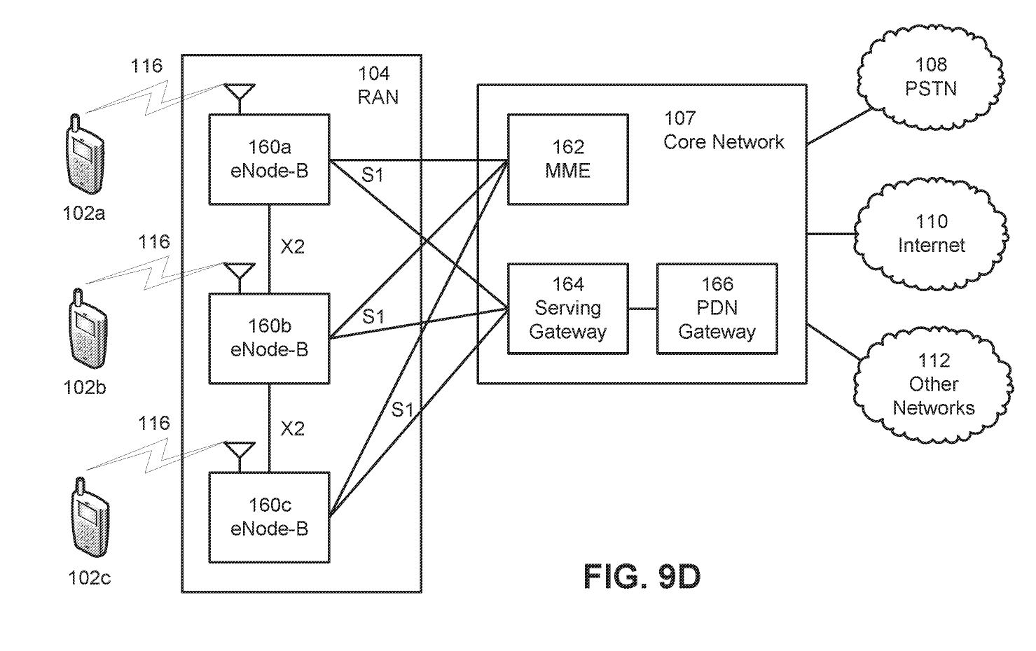

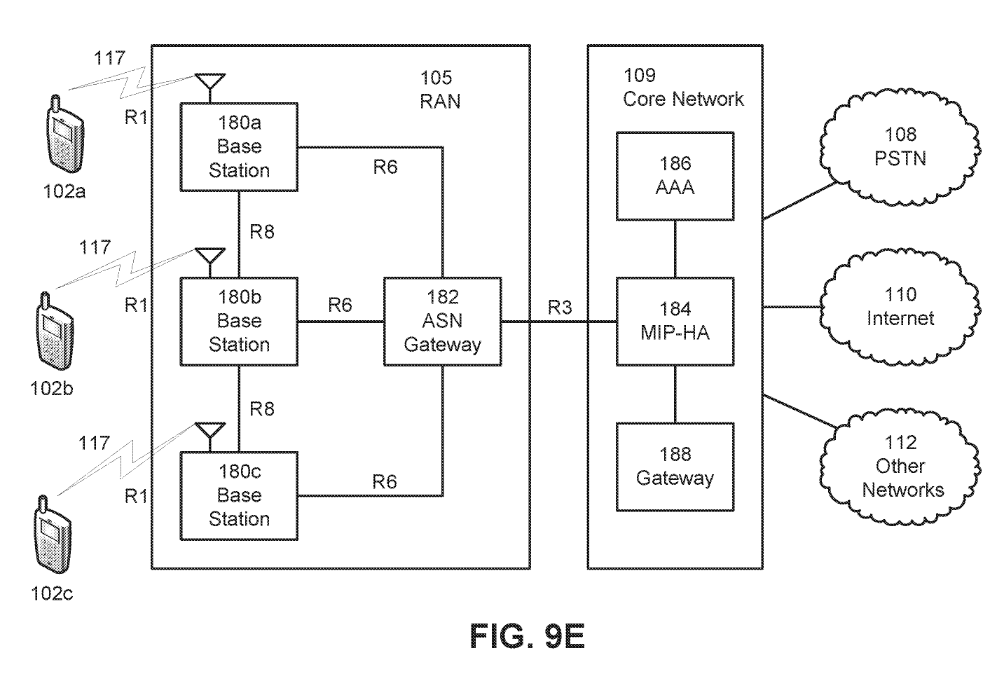

FIG. 9A is a diagram of an example communications system 100 in which one or more disclosed techniques may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 9A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed technology contemplates any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP) a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. In an example, the base station 114a may include three transceivers, i.e., one for each sector of the cell. In an example, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evoked HSPA (HSPA+). HSPA may include High-Speed Downlink Packet Access (HSDPA) and/or High-Speed Uplink Packet Access (HSUPA).

In an example, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In an example, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 9A may be a wireless router, Home Node B, Home eNode B, or access point, for example, and may utilize any suitable RAT for facilitating wireless connectivity in a localized area, such as a place of business, a home, a vehicle, a campus, and the like. In an example, the base station 114b and the WTRUs 102c, 102d may implement a radio technology such as IEEE 802.11 to establish a wireless local area network (WLAN). In an example, the base station 114b and the WTRUs 102c, 102d may implement a radio technology such as IEEE 802.15 to establish a wireless personal area network (WPAN). In an example, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 9A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over interact protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 9A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 9A may be configured to communicate with the base station 114a, which may employ a cellular-based radio technology, and with the base station 114b, which may employ an IEEE 802 radio technology.

FIG. 9B is a system diagram of an example WTRU 102. As shown in FIG. 9B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements. Base stations 114a and 114b, and/or the nodes that base stations 114a and 114b, may represent, for example but not limited to, transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 9B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 9B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. In an example, the transmit/receive element 122 may be an antenna configured to transmit and/or receive RF signals. In an example, the transmit/receive element 122 may be an emitter/detector configured to transmit and/or receive IR, UV, or visible light signals, for example. In an example, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 9B as a single element, the WTRU 102 may include any number of transmit/receive elements 122. More specifically, the WTRU 102 may employ MIMO technology. Thus, in an example, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have, multi-mode capabilities. Thus, the transceiver 120 may include multiple transceivers for enabling the WTRU 102 to communicate via multiple RATS, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an example, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination technique.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 9C is an example system diagram of the RAN 103 and the core network 106. As noted above, the RAN 103 may employ a UTRA radio technology to communicate with the WTRUs 102a, 102b, 102c over the air interface 115. The RAN 103 may also be in communication with the core network 106. As shown in FIG. 9C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown within the RAN 103. The RAN 103 may also include RNCs 142a, 142b. It will be appreciated that the RAN 103 may include any number of Node-Bs and RNCs.

As shown in FIG. 9C, the Node-Bs 140a, 140b may be in communication with the RNC 142a. Additionally, the Node-B 140c may be in communication with the RNC 142b. The. Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 9C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 9D is an example system diagram of the RAN 104 and the core network 107. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs. The eNode-Bs 160a, 160b, 160c may each include one or more transceivers for communicating with the WTRUs 102a, 102b, 102c over the air interface 116. In an example, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 9D, the eNode-Bs 160a, 160b, 160c may communicate with one another over an X2 interface.

The core network 107 shown in FIG. 9D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 9E is an example system diagram of the RAN 105 and the core network 109. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 9E, the RAN 105 may include base stations 180a, 180b, 180c, and an ASN gateway 182, though it will be appreciated that the RAN 105 may include any number of base stations and ASN gateways. The base stations 180a, 180b, 180c may each be associated with a particular cell (not shown) in the RAN 105 and may each include one or more transceivers for communicating with the WTRUs 102a, 102b, 102c over the air interface 117. In an example, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 9E, the RAN 105 may be connected to the core network 109. communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 9E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for supplying information about a user of a mobile device, comprising:
receiving a request for a characteristic of the user;
receiving criteria for one or more sensors of the mobile device allowable to be used in determining the characteristic of the user;
selecting one or more available sensors by comparing the request and the criteria to available sensors and the properties of the available sensors;
acquiring data from the selected available sensors;
determining a property of interest from the data, the property of interest corresponding to the characteristic of the user; and
sending the determined property of interest.

2. The method of claim 1, further comprising receiving criteria for one or more sensors of the mobile device not allowable to be used in determining the characteristic of the user.

3. The method of claim 1, wherein no sensor data is provided with the determined property of interest.

4. The method of claim 1, further comprising determining available on-device sensors and their properties.

5. The method of claim 1, further comprising determining available external device sensors and their properties.

6. The method of claim 1, wherein the determined property of interest represents a physical trait of the user.

7. The method of claim 1, wherein the determined property of interest is one or more of age, gender, ethnicity, weight, height, body mass index (BMI), or handedness.

8. The method of claim 1, wherein the determined property of interest is one or more of user activity, user relation to device, user attention, or user emotion.

9. The method of claim 1, further comprising determining a profile of the mobile device.

10. The method of claim 9, wherein the profile of the mobile device includes one or more of form-factor, size, weight, effective resolution, or effective contrast.

11. The method of claim 9, further comprising using the profile of the mobile device in determining the property of interest from the data.

12. The method of claim 1, further comprising storing a classifier for deriving a property of interest.

13. The method of claim 12, further comprising generating a set of classifiers based on the request for the characteristic of the user.

14. The method of claim 13, further comprising selecting a set of the most appropriate classifiers from the set of classifiers based on the criteria for the sensors.

15. The method of claim 12, further comprising storing criteria about the classifier.

16. The method of claim 15, wherein the classifier criteria includes information about one or more sensors that the classifier needs to acquire data from to determine the property of interest.

17. The method of claim 15, wherein the classifier criteria includes information about one or more of power requirements, degree of accuracy, or availability of sensor data.

18. The method of claim 14, further comprising selecting a best classifier from the set of the most appropriate classifiers based on one or more of power requirements, degree of accuracy, or availability of sensor data.

19.-36. (canceled)

37. A mobile device comprising:
one or more sensors; and
a processor configured to:
receive a request from an application for a characteristic of a user of the mobile device;
receive from the application criteria for one or more sensors of the mobile device allowable to be used in determining the characteristic;
determine a property of interest of the user corresponding to the user characteristic using sensor data obtained from sensors meeting the sensor criteria; and
provide the determined property of interest to the application without sensor data.

38. The mobile device of claim 37, wherein the sensor criteria includes which sensors of the device may not be used.

39. The mobile device of claim 37, wherein the sensor processing module obtains sensor data from external device sensors.

40. (canceled)
